(19) United States
(12) Patent Application Publication
(10) Pub. No.: US 2026/0299912 A1
(43) Pub. Date: Oct. 1, 2026

(54) System, Method, and Computer Program Product for Machine Learning Model Visualization and Optimized Deployment

(71) Applicant: Visa International Service Association, San Francisco, CA (US)

(72) Inventors: Junpeng Wang, Santa Clara, CA (US); Yuzhong Chen, Foster City, CA (US); Menghai Pan, San Jose, CA (US); Michael Yeh, Newark, CA (US); Mahashweta Das, Campbell, CA (US)

(21) Appl. No.: 19/629,454

(22) Filed: Mar. 26, 2026

Related U.S. Application Data
(60) Provisional application No. 63/779,622, filed on Mar. 28, 2025.

(51) Int. Cl. G06F 8/60; G06F 3/04842; G06F 8/35; G06F 11/362

(52) U.S. Cl. CPC G06F 8/60; G06F 3/04842; G06F 8/35; G06F 11/362

(57) ABSTRACT

Systems, methods, and computer program products are provided for machine learning model visualization and optimized deployment. An example system includes at least one processor configured to generate a first set of candidate code objects using a first machine learning model, determine, for each candidate code object of the first set of candidate code objects, at least one value of at least one performance parameter, and deploy a selected code object of the first set of candidate code objects in a production environment based at least partly on the selected code object having an optimized value of the at least one performance parameter.

### CROSS-REFERENCE TO RELATED APPLICATION

This application claims the benefit of United States Provisional Patent Application No. 63/779,622, filed Mar. 28, 2025, the disclosure of which is hereby incorporated by reference in its entirety.

### BACKGROUND

### 1. Technical Field

This disclosure relates generally to electronic payment processing networks and, in non-limiting embodiments or aspects, to systems, methods, and computer program products for machine learning model visualization and optimized deployment.

### 2. Technical Considerations

Coding agents powered by machine learning models (e.g., large language models) may automatically generate computer programming code (e.g., system programming code, application programming code, web development code, scripting code, database code, etc.) with minimal-to-no human involvement. However, due to the variability of function and quality among model-generated code samples, both by the same models and different models, it may be difficult to effectively determine which code objects and/or models are optimized (e.g., based on computer resource usage, performance parameters, etc.). Humans are not capable of manually inspecting individual code objects for performance, and manual review may not allow for deeper insights related to code evolution, differences in iterations, improvement opportunities, computer resource usage, runtime, and/or the like.

There is a need in the art for an improved system and method for generating code objects, comparing individual code objects (e.g., within and between different models), and implementing optimized code objects.

### SUMMARY

Accordingly, provided are improved systems, methods, and computer program products for machine learning model visualization and optimized deployment.

According to non-limiting embodiments or aspects, provided is a system for machine learning model visualization and optimized deployment. The system includes at least one processor. The at least one processor is configured to generate a first set of candidate code objects using a first machine learning model. When generating the first set of candidate code objects, the at least one processor is configured to generate at least one first candidate code object of the first set of candidate code objects without referencing an earlier-generated candidate code object of the first set of candidate code objects. When generating the first set of candidate code objects, the at least one processor is also configured to generate at least one second candidate code object of the first set of candidate code objects by debugging an earlier-generated candidate code object of the first set of candidate code objects that is non-functional. When generating the first set of candidate code objects, the at least one processor is further configured to generate at least one third candidate code object of the first set of candidate code objects by improving an earlier-generated candidate code object of the first set of candidate code objects that is functional. The at least one processor is also configured to determine, for each candidate code object of the first set of candidate code objects, at least one value of at least one performance parameter. The at least one processor is further configured to deploy a selected code object of the first set of candidate code objects in a production environment based at least partly on the selected code object having an optimized value of the at least one performance parameter.

In some non-limiting embodiments or aspects, the at least one processor may be configured to generate each candidate code object of the first set of candidate code objects in series.

In some non-limiting embodiments or aspects, the first set of candidate code objects may include at least thirty candidate code objects. When generating the first set of candidate code objects, the at least one processor may be configured to generate at least a first five generated candidate code objects of the first set of candidate code objects without referencing an earlier-generated candidate code object of the first set of candidate code objects.

In some non-limiting embodiments or aspects, when generating the first set of candidate code objects, the at least one processor may be configured to, after at least the first five generated candidate code objects are generated, generate a remainder of the first set of candidate code objects by debugging an earlier-generated candidate code object of the first set of candidate code objects that is non-functional, or improving an earlier-generated candidate code object of the first set of candidate code objects that is functional.

In some non-limiting embodiments or aspects, the at least one processor may be further configured to generate display data configured to represent the first set of candidate code objects as a hierarchical tree including a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node. The at least one processor may be further configured to cause the hierarchical tree to be displayed in a user interface based on the display data.

In some non-limiting embodiments or aspects, the at least one processor may be further configured to receive, via the user interface, a selection of a child node of the plurality of child nodes. The at least one processor may be further configured to generate, using a second machine learning model, a description based on how a candidate code object associated with the child node was generated using the first machine learning model. The at least one processor may be further configured to provide the description via the user interface.

In some non-limiting embodiments or aspects, the at least one performance parameter may include at least one of: a functional status of an executed code object, a runtime of an executed code object, a similarity of an executed code object to another code object, an error metric associated with a predictive performance of an executed code object, or any combination thereof.

In some non-limiting embodiments or aspects, the at least one processor may be further configured to generate a plurality of sets of candidate code objects using a plurality of machine learning models, wherein each set of the plurality of sets of candidate code objects is associated with a machine learning model of the plurality of machine learning models. When generating each set of candidate code objects, the at least one processor may be configured to generate at least one first candidate code object of the set of candidate code objects without referencing an earlier-generated candidate code object of the set of candidate code objects. When generating each set of candidate code objects, the at least one processor may also be configured to generate at least one second candidate code object of the set of candidate code objects by debugging an earlier-generated candidate code object of the set of candidate code objects that is non-functional. When generating each set of candidate code objects, the at least one processor may be further configured to generate at least one third candidate code object of the set of candidate code objects by improving an earlier-generated candidate code object of the set of candidate code objects that is functional.

In some non-limiting embodiments or aspects, the at least one processor may be further configured to generate display data configured to represent each set of the plurality of sets of candidate code objects as at least a respective root node of a plurality of root nodes. Each root node of the plurality of root nodes may be configured to be rendered visually based at least partly on a proportion of candidate code objects that are functional in a set of candidate code objects associated with the root node.

In some non-limiting embodiments or aspects, the at least one processor may be further configured to generate a multi-dimensional embedding associated with each candidate code object of each set of candidate code objects of the plurality of sets of candidate code objects, to produce a plurality of multi-dimensional embeddings, each dimension of the multi-dimensional embedding based on content of the candidate code object or associated with a performance parameter of the candidate code object. The at least one processor may be further configured to display a visual representation of the plurality of multi-dimensional embeddings in a two-dimensional graph using a two-dimensional projection of the plurality of multi-dimensional embeddings. Embeddings of the plurality of multi-dimensional embeddings associated with code objects generated by a same machine learning model may be rendered using at least one common visual parameter.

According to some non-limiting embodiments or aspects, provided is a computer-implemented method for machine learning model visualization and optimized deployment. The method includes generating, with at least one processor, a first set of candidate code objects using a first machine learning model. Generating the first set of candidate code objects includes generating at least one first candidate code object of the first set of candidate code objects without referencing an earlier-generated candidate code object of the first set of candidate code objects. Generating the first set of candidate code objects includes generating at least one second candidate code object of the first set of candidate code objects by debugging an earlier-generated candidate code object of the first set of candidate code objects that is non-functional. Generating the first set of candidate code objects includes generating at least one third candidate code object of the first set of candidate code objects by improving an earlier-generated candidate code object of the first set of candidate code objects that is functional. The method also includes determining, with at least one processor, for each candidate code object of the first set of candidate code objects, at least one value of at least one performance parameter. The method further includes deploying, with at least one processor, a selected code object of the first set of candidate code objects in a production environment based at least partly on the selected code object having an optimized value of the at least one performance parameter.

In some non-limiting embodiments or aspects, the method may further include generating, with at least one processor, display data configured to represent the first set of candidate code objects as a hierarchical tree including a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node. The method may further include causing, with at least one processor, the hierarchical tree to be displayed in a user interface based on the display data.

In some non-limiting embodiments or aspects, the method may further include generating, with at least one processor, a plurality of sets of candidate code objects using a plurality of machine learning models. Each set of the plurality of sets of candidate code objects may be associated with a machine learning model of the plurality of machine learning models. Generating each set of candidate code objects may include generating at least one first candidate code object of the set of candidate code objects without referencing an earlier-generated candidate code object of the set of candidate code objects. Generating each set of candidate code objects may include generating at least one second candidate code object of the set of candidate code objects by debugging an earlier-generated candidate code object of the set of candidate code objects that is non-functional. Generating each set of candidate code objects may include generating at least one third candidate code object of the set of candidate code objects by improving an earlier-generated candidate code object of the set of candidate code objects that is functional.

In some non-limiting embodiments or aspects, the method may also include generating, with at least one processor, display data configured to represent each set of the plurality of sets of candidate code objects as at least a respective root node of a plurality of root nodes. Each root node of the plurality of root nodes may be configured to be rendered visually based at least partly on a proportion of candidate code objects that are functional in a set of candidate code objects associated with the root node.

In some non-limiting embodiments or aspects, the method may also include generating, with at least one processor, a multi-dimensional embedding associated with each candidate code object of each set of candidate code objects of the plurality of sets of candidate code objects, to produce a plurality of multi-dimensional embeddings. Each dimension of the multi-dimensional embedding may be based on content of the candidate code object or associated with a performance parameter of the candidate code object. The method may further include displaying, with at least one processor, a visual representation of the plurality of multi-dimensional embeddings in a two-dimensional graph using a two-dimensional projection of the plurality of multi-dimensional embeddings. Embeddings of the plurality of multi-dimensional embeddings associated with code objects generated by a same machine learning model may be rendered using at least one common visual parameter.

According to some non-limiting embodiments or aspects, provided is a computer program product for machine learning model visualization and optimized deployment. The computer program product includes at least one non-transitory computer-readable medium including program instructions that, when executed by at least one processor, cause the at least one processor to generate a first set of candidate code objects using a first machine learning model. The program instructions that cause the at least one processor to generate the first set of candidate code objects cause the at least one processor to generate at least one first candidate code object of the first set of candidate code objects without referencing an earlier-generated candidate code object of the first set of candidate code objects. The program instructions that cause the at least one processor to generate the first set of candidate code objects also cause the at least one processor to generate at least one second candidate code object of the first set of candidate code objects by debugging an earlier-generated candidate code object of the first set of candidate code objects that is non-functional. The program instructions that cause the at least one processor to generate the first set of candidate code objects further cause the at least one processor to generate at least one third candidate code object of the first set of candidate code objects by improving an earlier-generated candidate code object of the first set of candidate code objects that is functional. The program instructions further cause the at least one processor to determine, for each candidate code object of the first set of candidate code objects, at least one value of at least one performance parameter. The program instructions further cause the at least one processor to deploy a selected code object of the first set of candidate code objects in a production environment based at least partly on the selected code object having an optimized value of the at least one performance parameter.

In some non-limiting embodiments or aspects, the program instructions may further cause the at least one processor to generate display data configured to represent the first set of candidate code objects as a hierarchical tree including a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node. The program instructions may further cause the at least one processor to cause the hierarchical tree to be displayed in a user interface based on the display data.

In some non-limiting embodiments or aspects, the program instructions may further cause the at least one processor to generate a plurality of sets of candidate code objects using a plurality of machine learning models, wherein each set of the plurality of sets of candidate code objects is associated with a machine learning model of the plurality of machine learning models. The program instructions that cause the at least one processor to generate each set of candidate code objects may cause the at least one processor to generate at least one first candidate code object of the set of candidate code objects without referencing an earlier-generated candidate code object of the set of candidate code objects. The program instructions that cause the at least one processor to generate each set of candidate code objects may also cause the at least one processor to generate at least one second candidate code object of the set of candidate code objects by debugging an earlier-generated candidate code object of the set of candidate code objects that is non-functional. The program instructions that cause the at least one processor to generate each set of candidate code objects may further cause the at least one processor to generate at least one third candidate code object of the set of candidate code objects by improving an earlier-generated candidate code object of the set of candidate code objects that is functional.

In some non-limiting embodiments or aspects, the program instructions may further cause the at least one processor to generate display data configured to represent each set of the plurality of sets of candidate code objects as at least a respective root node of a plurality of root nodes. Each root node of the plurality of root nodes may be configured to be rendered visually based at least partly on a proportion of candidate code objects that are functional in a set of candidate code objects associated with the root node.

In some non-limiting embodiments or aspects, the program instructions may further cause the at least one processor to generate a multi-dimensional embedding associated with each candidate code object of each set of candidate code objects of the plurality of sets of candidate code objects, to produce a plurality of multi-dimensional embeddings. Each dimension of the multi-dimensional embedding may be based on content of the candidate code object or associated with a performance parameter of the candidate code object. The program instructions may further cause the at least one processor to display a visual representation of the plurality of multi-dimensional embeddings in a two-dimensional graph using a two-dimensional projection of the plurality of multi-dimensional embeddings. Embeddings of the plurality of multi-dimensional embeddings associated with code objects generated by a same machine learning model may be rendered using at least one common visual parameter.

Further non-limiting embodiments or aspects are set forth in the following numbered clauses:

Clause 1: A system, comprising: at least one processor configured to: generate a first set of candidate code objects using a first machine learning model, wherein, when generating the first set of candidate code objects, the at least one processor is configured to: generate at least one first candidate code object of the first set of candidate code objects without referencing an earlier-generated candidate code object of the first set of candidate code objects; generate at least one second candidate code object of the first set of candidate code objects by debugging an earlier-generated candidate code object of the first set of candidate code objects that is non-functional; and generate at least one third candidate code object of the first set of candidate code objects by improving an earlier-generated candidate code object of the first set of candidate code objects that is functional; determine, for each candidate code object of the first set of candidate code objects, at least one value of at least one performance parameter; and deploy a selected code object of the first set of candidate code objects in a production environment based at least partly on the selected code object having an optimized value of the at least one performance parameter.

Clause 2: The system of clause 1, wherein the at least one processor is configured to generate each candidate code object of the first set of candidate code objects in series.

Clause 3: The system of clause 1 or 2, wherein the first set of candidate code objects comprises at least thirty candidate code objects, and wherein, when generating the first set of candidate code objects, the at least one processor is configured to generate at least a first five generated candidate code objects of the first set of candidate code objects without referencing an earlier-generated candidate code object of the first set of candidate code objects.

Clause 4: The system of any of clauses 1-3, wherein, when generating the first set of candidate code objects, the at least one processor is configured to, after at least the first five generated candidate code objects are generated, generate a remainder of the first set of candidate code objects by debugging an earlier-generated candidate code object of the first set of candidate code objects that is non-functional, or improving an earlier-generated candidate code object of the first set of candidate code objects that is functional.

Clause 5: The system of any of clauses 1-4, wherein the at least one processor is further configured to: generate display data configured to represent the first set of candidate code objects as a hierarchical tree comprising a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node; and cause the hierarchical tree to be displayed in a user interface based on the display data.

Clause 6: The system of any of clauses 1-5, wherein the at least one processor is further configured to: receive, via the user interface, a selection of the child node of the plurality of child nodes; generate, using a second machine learning model, a description based on how a candidate code object associated with the child node was generated using the first machine learning model; and provide the description via the user interface.

Clause 7: The system of any of clauses 1-6, wherein the at least one performance parameter comprises at least one of: a functional status of an executed code object; a runtime of an executed code object; a similarity of an executed code object to another code object; an error metric associated with a predictive performance of an executed code object; or any combination thereof.

Clause 8: The system of any of clauses 1-7, wherein the at least one processor is further configured to generate a plurality of sets of candidate code objects using a plurality of machine learning models, wherein each set of the plurality of sets of candidate code objects is associated with a machine learning model of the plurality of machine learning models, and wherein, when generating each set of candidate code objects, the at least one processor is configured to: generate at least one first candidate code object of the set of candidate code objects without referencing an earlier-generated candidate code object of the set of candidate code objects; generate at least one second candidate code object of the set of candidate code objects by debugging an earlier-generated candidate code object of the set of candidate code objects that is non-functional; and generate at least one third candidate code object of the set of candidate code objects by improving an earlier-generated candidate code object of the set of candidate code objects that is functional.

Clause 9: The system of any of clauses 1-8, wherein the at least one processor is further configured to generate display data configured to represent each set of the plurality of sets of candidate code objects as at least a respective root node of a plurality of root nodes, and wherein each root node of the plurality of root nodes is configured to be rendered visually based at least partly on a proportion of candidate code objects that are functional in a set of candidate code objects associated with the root node.

Clause 10: The system of any of clauses 1-9, wherein the at least one processor is further configured to: generate a multi-dimensional embedding associated with each candidate code object of each set of candidate code objects of the plurality of sets of candidate code objects, to produce a plurality of multi-dimensional embeddings, each dimension of the multi-dimensional embedding based on content of the candidate code object or associated with a performance parameter of the candidate code object; and display a visual representation of the plurality of multi-dimensional embeddings in a two-dimensional graph using a two-dimensional projection of the plurality of multi-dimensional embeddings, wherein embeddings of the plurality of multi-dimensional embeddings associated with candidate code objects generated by a same machine learning model are rendered using at least one common visual parameter.

Clause 11: A computer-implemented method, comprising: generating, with at least one processor, a first set of candidate code objects using a first machine learning model, wherein generating the first set of candidate code objects comprises: generating at least one first candidate code object of the first set of candidate code objects without referencing an earlier-generated candidate code object of the first set of candidate code objects; generating at least one second candidate code object of the first set of candidate code objects by debugging an earlier-generated candidate code object of the first set of candidate code objects that is non-functional; and generating at least one third candidate code object of the first set of candidate code objects by improving an earlier-generated candidate code object of the first set of candidate code objects that is functional; determining, with at least one processor, for each candidate code object of the first set of candidate code objects, at least one value of at least one performance parameter; and deploying, with at least one processor, a selected code object of the first set of candidate code objects in a production environment based at least partly on the selected code object having an optimized value of the at least one performance parameter.

Clause 12: The computer-implemented method of clause 11, further comprising: generating, with at least one processor, display data configured to represent the first set of candidate code objects as a hierarchical tree comprising a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node; and causing, with at least one processor, the hierarchical tree to be displayed in a user interface based on the display data.

Clause 13: The computer-implemented method of clause 11 or 12, further comprising generating, with at least one processor, a plurality of sets of candidate code objects using a plurality of machine learning models, wherein each set of the plurality of sets of candidate code objects is associated with a machine learning model of the plurality of machine learning models, and wherein generating each set of candidate code objects comprises: generating at least one first candidate code object of the set of candidate code objects without referencing an earlier-generated candidate code object of the set of candidate code objects; generating at least one second candidate code object of the set of candidate code objects by debugging an earlier-generated candidate code object of the set of candidate code objects that is non-functional; and generating at least one third candidate code object of the set of candidate code objects by improving an earlier-generated candidate code object of the set of candidate code objects that is functional.

Clause 14: The computer-implemented method of any of clauses 11-13, further comprising generating, with at least one processor, display data configured to represent each set of the plurality of sets of candidate code objects as at least a respective root node of a plurality of root nodes, wherein each root node of the plurality of root nodes is configured to be rendered visually based at least partly on a proportion of candidate code objects that are functional in a set of candidate code objects associated with the root node.

Clause 15: The computer-implemented method of any of clauses 11-14, further comprising: generating, with at least one processor, a multi-dimensional embedding associated with each candidate code object of each set of candidate code objects of the plurality of sets of candidate code objects, to produce a plurality of multi-dimensional embeddings, each dimension of the multi-dimensional embedding based on content of the candidate code object or associated with a performance parameter of the candidate code object; and displaying, with at least one processor, a visual representation of the plurality of multi-dimensional embeddings in a two-dimensional graph using a two-dimensional projection of the plurality of multi-dimensional embeddings, wherein embeddings of the plurality of multi-dimensional embeddings associated with candidate code objects generated by a same machine learning model are rendered using at least one common visual parameter.

Clause 16: A computer program product comprising at least one non-transitory computer-readable medium including program instructions that, when executed by at least one processor, cause the at least one processor to: generate a first set of candidate code objects using a first machine learning model, wherein the program instructions that cause the at least one processor to generate the first set of candidate code objects cause the at least one processor to: generate at least one first candidate code object of the first set of candidate code objects without referencing an earlier-generated candidate code object of the first set of candidate code objects; generate at least one second candidate code object of the first set of candidate code objects by debugging an earlier-generated candidate code object of the first set of candidate code objects that is non-functional; and generate at least one third candidate code object of the first set of candidate code objects by improving an earlier-generated candidate code object of the first set of candidate code objects that is functional; determine, for each candidate code object of the first set of candidate code objects, at least one value of at least one performance parameter; and deploy a selected code object of the first set of candidate code objects in a production environment based at least partly on the selected code object having an optimized value of the at least one performance parameter.

Clause 17: The computer program product of clause 16, wherein the program instructions further cause the at least one processor to: generate display data configured to represent the first set of candidate code objects as a hierarchical tree comprising a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node; and cause the hierarchical tree to be displayed in a user interface based on the display data.

Clause 18: The computer program product of clause 16 or 17, wherein the program instructions further cause the at least one processor to generate a plurality of sets of candidate code objects using a plurality of machine learning models, wherein each set of the plurality of sets of candidate code objects is associated with a machine learning model of the plurality of machine learning models, and wherein the program instructions that cause the at least one processor to generate each set of candidate code objects cause the at least one processor to: generate at least one first candidate code object of the set of candidate code objects without referencing an earlier-generated candidate code object of the set of candidate code objects; generate at least one second candidate code object of the set of candidate code objects by debugging an earlier-generated candidate code object of the set of candidate code objects that is non-functional; and generate at least one third candidate code object of the set of candidate code objects by improving an earlier-generated candidate code object of the set of candidate code objects that is functional.

Clause 19: The computer program product of any of clauses 16-18, wherein the program instructions further cause the at least one processor to generate display data configured to represent each set of the plurality of sets of candidate code objects as at least a respective root node of a plurality of root nodes, and wherein each root node of the plurality of root nodes is configured to be rendered visually based at least partly on a proportion of candidate code objects that are functional in a set of candidate code objects associated with the root node.

Clause 20: The computer program product of any of clauses 16-19, wherein the program instructions further cause the at least one processor to: generate a multi-dimensional embedding associated with each candidate code object of each set of candidate code objects of the plurality of sets of candidate code objects, to produce a plurality of multi-dimensional embeddings, each dimension of the multi-dimensional embedding based on content of the candidate code object or associated with a performance parameter of the candidate code object; and display a visual representation of the plurality of multi-dimensional embeddings in a two-dimensional graph using a two-dimensional projection of the plurality of multi-dimensional embeddings, wherein embeddings of the plurality of multi-dimensional embeddings associated with candidate code objects generated by a same machine learning model are rendered using at least one common visual parameter.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for machine learning model visualization and optimized deployment, according to some non-limiting embodiments or aspects;

FIG. 2 is a schematic diagram of example components of one or more devices of FIG. 1, according to some non-limiting embodiments or aspects;

FIG. 3 is a flow diagram of a method for machine learning model visualization and optimized deployment, according to some non-limiting embodiments or aspects;

FIG. 4 is a schematic diagram of a system for machine learning model visualization and optimized deployment, according to some non-limiting embodiments or aspects;

FIG. 5A is an exemplary diagram of a tree structure created by the described systems and methods, according to some non-limiting embodiments or aspects;

FIG. 5B is an example agent plan related to the tree structure of FIG. 5A created by the described systems and methods, according to some non-limiting embodiments or aspects;

FIG. 5C is an example code view related to the tree structure of FIG. 5A created by the described systems and methods, according to some non-limiting embodiments or aspects;

FIG. 5D is an example code analysis view related to the code view of FIG. 5C created by the described systems and methods, according to some non-limiting embodiments or aspects;

FIG. 6 is an exemplary diagram and tables comparing multiple models, according to some non-limiting embodiments or aspects;

FIG. 7A is an exemplary dendrogram for a first portion of models from the tables of FIG. 6, according to some non-limiting embodiments or aspects;

FIG. 7B is an exemplary dendrogram for a second portion of models from the tables of FIG. 6, according to some non-limiting embodiments or aspects;

FIG. 8 is an exemplary scatterplot of the code reflected in the tables of FIG. 6, according to some non-limiting embodiments or aspects;

FIG. 9 is an exemplary bar matrix of the packages used in the codes reflected in the tables of FIG. 6, according to some non-limiting embodiments or aspects; and

FIG. 10 is a schematic diagram of a system for machine learning model visualization and optimized deployment, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “the device,” “a server,” “the server,” “a processor,” “the processor,” “a computing device,” “the computing device,” and/or the like, as used herein, may refer to a previously-recited device, server, processor, or computing device that is recited as performing a previous step or function, a different device, server, processor, or computing device, and/or a combination of devices, servers, processors, and/or computing devices. For example, as used in the specification and the claims, a first device, a first server, a first processor, or a first computing device that is recited as performing a first step or a first function may refer to the same or different device, server, processor, or computing device recited as performing a second step or a second function.

Non-limiting embodiments described herein provide for systems and methods for machine learning model visualization and optimized deployment, enabling machine learning models to automatically trigger debugging and/or improvement of candidate code objects. Non-limiting embodiments also allow identification of machine learning models that frequently produce candidate code objects that are non-functional (e.g., buggy, wherein the code object does not terminate properly), enabling selection of only machine learning models that produce candidate code objects that are functional to reduce stress on a processor. The described systems and methods functionally improve computer-driven modeling systems by reducing the production and deployment of non-functional code objects in the system.

The described systems and methods further allocate computer resources more efficiently through staged generation of candidate code objects. After a first round of independently drafted code objects (e.g., at least five code objects), without reference to prior-generated code objects, a modeling system may then generate a new independent draft, choose a functional code object that was generated and improve it (e.g., an improvement process), and/or choose a non-functional code object that was generated and fix it (e.g., a debugging process). Families of nodes may be related to one another in a hierarchical tree, to improve salience of data relationships. Moreover, this technique allows for rapidly prototyping code objects to achieve a more computationally efficient state, where the later generations of code objects are typically more likely to be functional and more efficient (e.g., due to recurrent debugging and improvement) than their predecessors. Code objects may then be assessed according to performance parameters, such that a best code object may be selected for deployment. A best code object may be selected and deployed from within one model type, or by using another model type. In the latter case, families of code objects in a same model type may be compared performatively against families of code objects in a different model type to identify and deploy a most optimal and computer-resource-efficient machine learning model.

Further to the described systems and methods herein, coding agents powered by large language models (LLMs) may be used for automating code generation through iterative problem-solving with minimal human involvement. By leveraging detailed prompts and evaluation metrics, these agents may continuously refine their solutions. They address the challenge of tracking code evolution, comparing different coding iterations, and identifying improvement opportunities. The described systems and methods employ a visual analytics system designed to enhance the examination of coding agent behaviors. The described systems and methods support comparative analysis across three levels: (1) code-level analysis, which may reveal how a coding agent debugs and refines its code over iterations; (2) solution-seeking process analysis, which may contrast different problem-solving strategies employed by a coding agent; and (3) LLM-level analysis, which may highlight variations in coding behavior across different LLMs. By integrating these perspectives, the described systems and methods enable a structured and holistic understanding of agent behaviors, facilitating more effective debugging and prompt engineering. Moreover, the described systems and methods enhance transparency and interpretability, providing valuable insights into the iterative coding process.

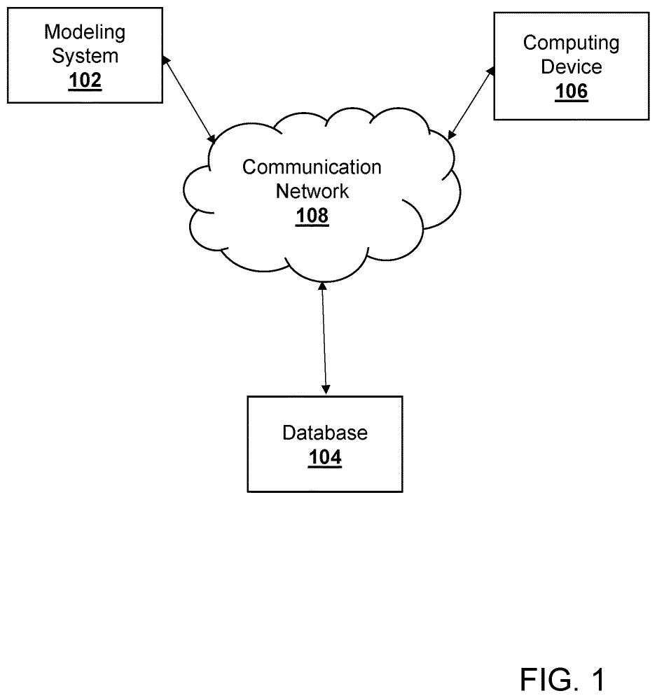

Referring now to FIG. 1, shown is a schematic diagram of system 100 in which devices, systems, and/or methods, described herein, may be implemented, according to some non-limiting embodiments or aspects. As shown in FIG. 1, system 100 may include modeling system 102, database 104, and/or computing device 106, which may communicate at least partly over communication network 108.

Modeling system 102 may include one or more computing devices configured to communicate with database 104 and/or computing device 106 at least partly over communication network 108. Modeling system 102 may be configured to generate code objects using one or more machine learning models, analyze the performance of one or more machine learning models, summarize the performance of one or more machine learning models, and/or deploy optimized code objects from one or more machine learning models. Modeling system 102 may include or be in communication with database 104 and/or computing device 106. Modeling system 102 may be associated with, or included in a same system as, database 104 and/or computing device 106.

Database 104 may include one or more computing devices configured to communicate with modeling system 102 and/or computing device 106 at least partly over communication network 108. Database 104 may be configured to store one or more machine learning models, store one or more generated code objects, store information related to the generation and analysis of code objects, and/or the like. Database 104 may include or be in communication with modeling system 102 and/or computing device 106. Database 104 may be associated with, or included in a same system as, modeling system 102 and/or computing device 106.

Computing device 106 may include one or more computing devices configured to communicate with modeling system 102 and/or computing device 106 at least partly over communication network 108. Computing device 106 may be configured to operate a user interface configured to display data, transmit data to modeling system 102 and/or database 104, receive data from modeling system 102 and/or database 104, and/or the like. Computing device 106 may include or be in communication with database 104 and/or modeling system 102. Computing device 106 may be associated with, or included in a same system as, database 104 and/or modeling system 102.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of system 100 may perform one or more functions described as being performed by another set of systems or another set of devices of system 100.

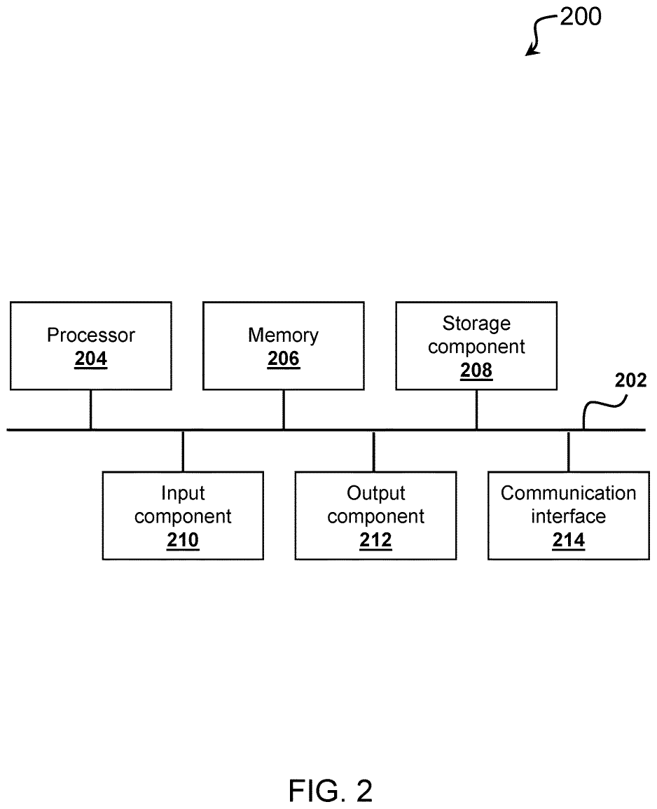

Referring now to FIG. 2, shown is a diagram of example components of device 200, according to non-limiting embodiments. Device 200 may correspond to modeling system 102, database 104, computing device 106, communication network 108, machine learning model coding system 402, machine learning model coding system 404, machine learning model analysis system 406, or machine learning model summary system 408, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

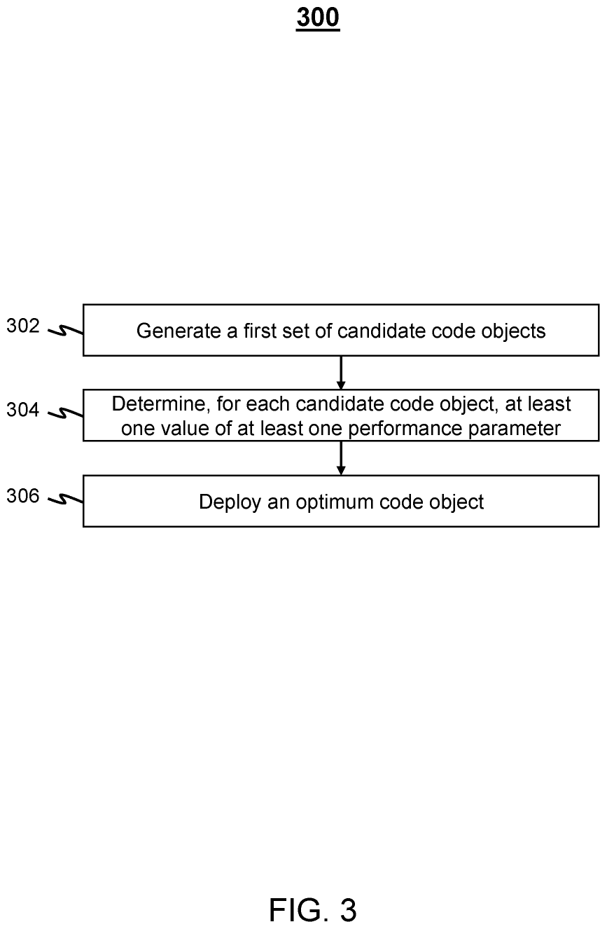

Referring now to FIG. 3, shown is a flow diagram of method 300 for machine learning model visualization and optimized deployment, according to some non-limiting embodiments or aspects. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of method 300 may be performed (e.g., completely, partially, and/or the like) by modeling system 102. In some non-limiting embodiments or aspects, one or more of the steps of method 300 may be performed (e.g., completely, partially, and/or the like) by another system, another device, another group of systems, or another group of devices, separate from or including modeling system 102.

As shown in FIG. 3, at step 302, method 300 may include generating a first set of candidate code objects. For example, modeling system 102 may generate a first set of candidate code objects using a first machine learning model.

In some non-limiting embodiments or aspects, modeling system 102 may generate the first set of candidate code objects by, at least partly, generating at least one first candidate code object of the first set of candidate code objects without referencing an earlier-generated candidate code object of the first set of candidate code objects. In some non-limiting embodiments or aspects, modeling system 102 may generate the first set of candidate code objects by, at least partly, generating at least one second candidate code object of the first set of candidate code objects by debugging an earlier-generated candidate code object of the first set of candidate code objects that is non-functional. In some non-limiting embodiments or aspects, modeling system 102 may generate the first set of candidate code objects by, at least partly, generating at least one third candidate code object of the first set of candidate code objects by improving an earlier-generated candidate code object of the first set of candidate code objects that is functional.

As shown in FIG. 3, at step 304, method 300 may include determining, for each candidate code object of the first set of candidate code objects, at least one value of at least one performance parameter. For example, modeling system 102 may determine, for each candidate code object of the first set of candidate code objects, at least one value of at least one performance parameter.

As shown in FIG. 3, at step 306, method 300 may include deploying an optimum code object. For example, modeling system 102 may deploy a selected code object of the first set of candidate code objects in a production environment based at least partly on the selected code object having an optimized value of the at least one performance parameter (e.g., automatically by modeling system 102 based on a performance parameter satisfying a threshold value and/or in response to a user selection of an optimal code object).

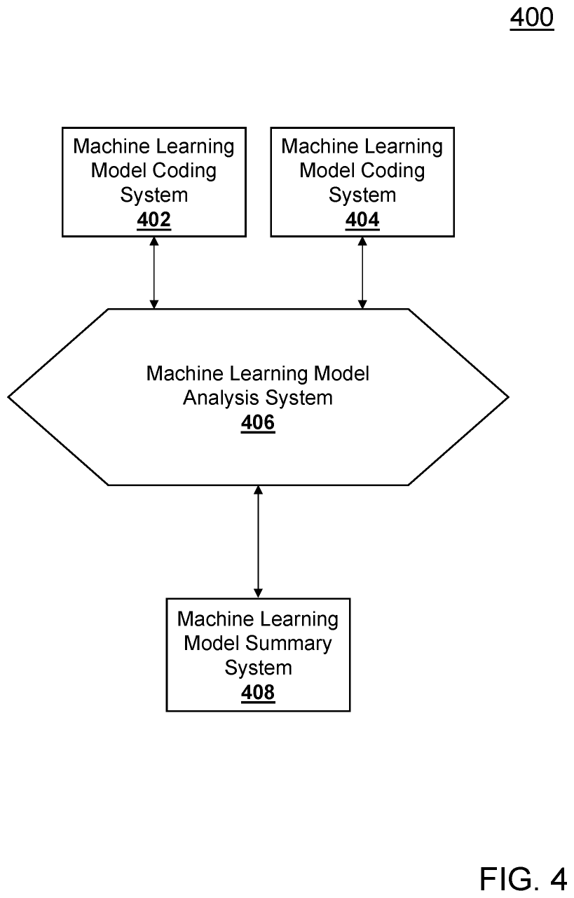

Referring now to FIG. 4, shown is system 400 (e.g., modeling system 102) for machine learning model visualization and optimized deployment, according to some non-limiting embodiments or aspects. System 400 may include machine learning model coding system 402, machine learning model analysis system 406, and machine learning model summary system 408. In some non-limiting embodiments or aspects, the system may also include machine learning model coding system 404.

Machine learning model coding systems 402, 404 may include one or more computing devices executing one or more software applications, as an example. Machine learning model coding systems 402, 404 may employ a machine learning model (e.g., an LLM) to generate a set of candidate code objects. Machine learning model analysis system 406 may include one or more computing devices executing one or more software applications, as an example. Machine learning model analysis system 406 may employ a machine learning model (e.g., an LLM) to perform analysis. Machine learning model summary system 408 may include one or more computing devices executing one or more software applications, as an example. Machine learning model summary system 408 may receive analysis reports from machine learning model analysis system 406. Machine learning model summary system 408 may employ a machine learning model (e.g., an LLM) to prepare a final summary of all the analysis received from machine learning model analysis system 406.

Machine learning model coding systems 402, 404 may generate a set of candidate code objects. Each set may be associated with one of machine learning model coding systems 402 or 404. Machine learning model coding systems 402, 404 may generate a set of candidate code objects by generating at least one first candidate code object without referencing an earlier-generated candidate code object. Machine learning model coding systems 402, 404 may generate a set of candidate code objects by generating at least one second candidate code object by debugging an earlier-generated candidate code object that is non-functional. Machine learning model coding systems 402, 404 may generate a set of candidate code objects by generating at least one third candidate code object by improving an earlier-generated candidate code object that is functional. Machine learning model coding systems 402, 404 may represent two different systems, although it will be appreciated that embodiments may use a single or many LLMs. Machine learning model coding systems 402, 404 may be local to machine learning model analysis system 406 or may be remote systems that are interacted with through a network environment, such as through one or more application programming interfaces (APIs) exposed by machine learning model coding systems 402, 404.

Machine learning model coding systems 402, 404 may generate a set of candidate code objects in series. Machine learning model coding systems 402, 404 may generate at least thirty candidate code objects. Machine learning model coding systems 402, 404 may generate at least a first five candidate code objects without referencing an earlier-generated candidate code object. Machine learning model coding systems 402, 404 may generate the remaining candidate code objects by debugging an earlier-generated candidate code object that is non-functional or improving an earlier-generated candidate code object that is functional.

Machine learning model analysis system 406 may determine at least one value for at least one performance parameter for a candidate code object. The at least one performance parameter may be at least one of: a functional status of an executed code object; a runtime of an executed code object; a similarity of an executed code object to another code object; an error metric associated with a predictive performance of an executed code object; or any combination thereof. Machine learning model analysis system 406 may deploy a selected code object of the first set of candidate code objects in a production environment based at least partly on the selected code object having an optimized value of the at least one performance parameter.

Machine learning model summary system 408 may generate display data, such that a set of candidate code objects is represented as a hierarchical tree comprising a root node and a plurality of child nodes. The root node may be associated with machine learning model coding systems 402, 404 that created the set of candidate code objects, and each child node may be associated with one of the candidate code objects.

The root node may be configured to be rendered visually based at least partly on a proportion of candidate code objects that are functional in a set of candidate code objects associated with the root node. Each child node may be configured to be rendered visually based on the at least one value of the at least one performance parameter of the candidate code object associated with the child node. Machine learning model summary system 408 may cause the hierarchical tree to be displayed in a user interface based on the display data.

Machine learning model analysis system 406 may receive a selection of a child node and generate a description based on how the associated candidate code object was generated. Machine learning model analysis system 406 may provide the description via the user interface.

Machine learning model summary system 408 may generate a multi-dimensional embedding associated with each candidate code object. Each dimension of the multi-dimensional embedding may be based on content of the candidate code object or associated with a performance parameter of the candidate code object. Machine learning model summary system 408 may display a visual representation of the multi-dimensional embeddings in a two-dimensional graph using a two-dimensional projection of the plurality of multi-dimensional embeddings. The embeddings associated with the set of candidate code objects produced by one of machine learning model coding systems 402, 404 may be rendered using at least one common visual parameter. The visual parameter may be color.

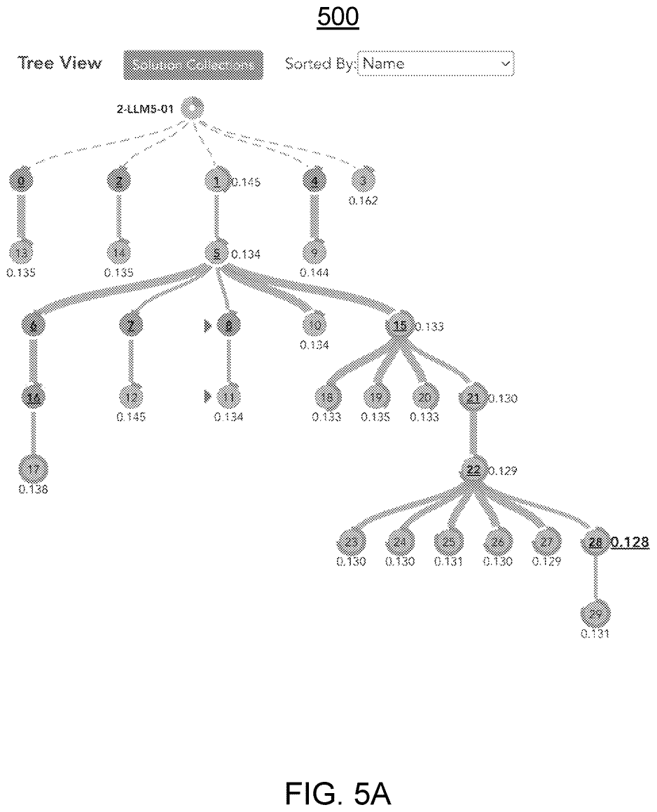

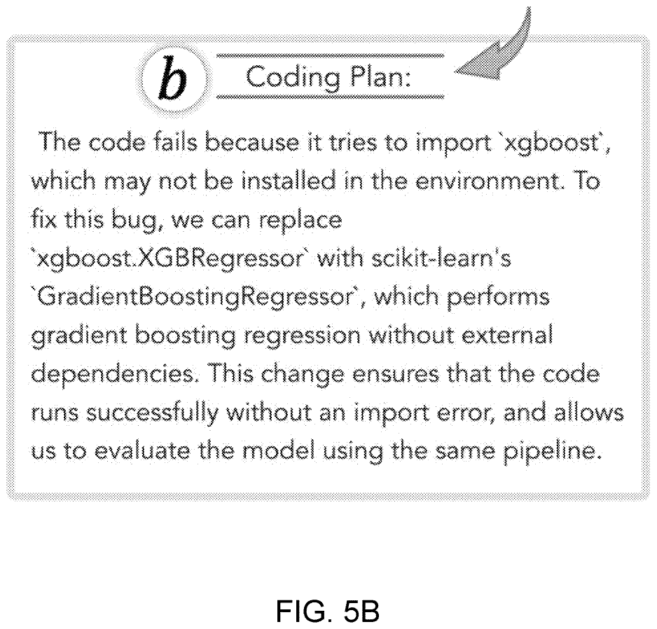

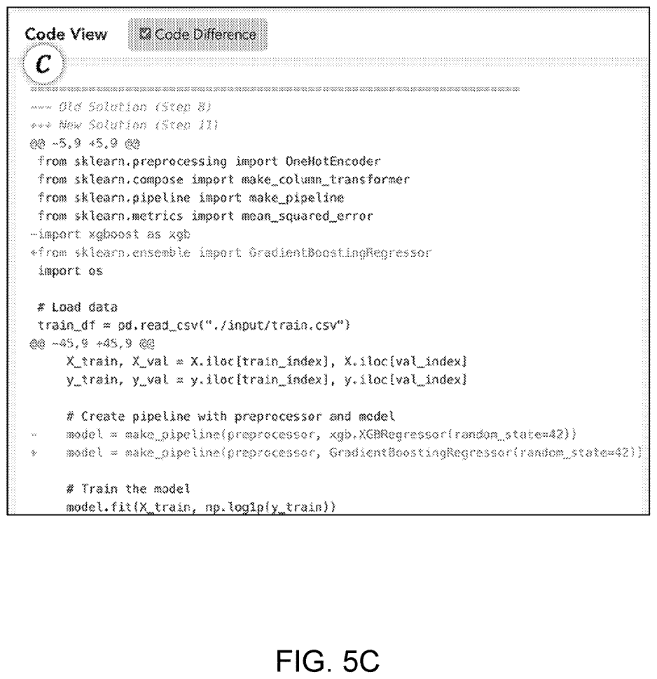

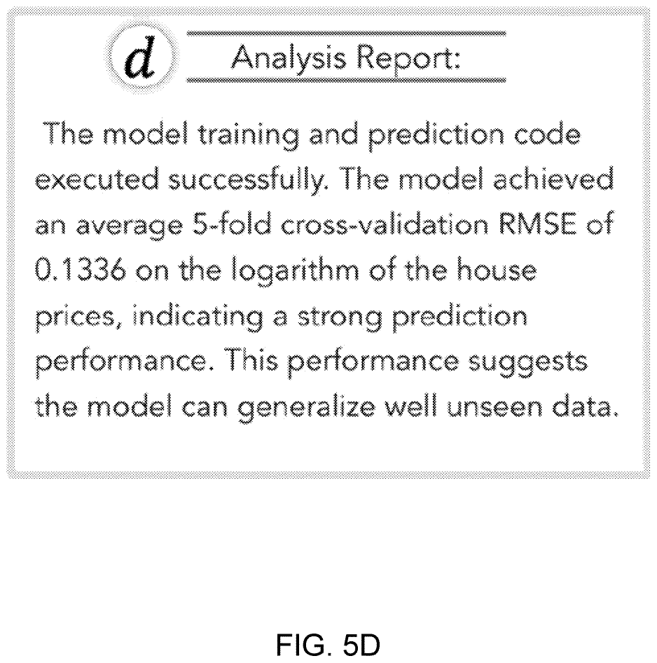

Referring now to FIGS. 5A-5D, provided are example views of display data 500, according to some non-limiting embodiments or aspects. FIGS. 5A-5D may be combined to be displayed on a user's computing device (e.g., computing device 106) as a single view or multiple views or displayed separately as multiple views. FIG. 5A is an exemplary diagram of a tree structure created by the described systems and methods, FIG. 5B is an example agent plan related to the tree structure of FIG. 5A created by the described systems and methods (and which may be overlaid or displayed adjacent to FIG. 5A). FIG. 5C is an example code view related to the tree structure of FIG. 5A created by the described systems and methods (and which may be overlaid or displayed adjacent to FIGS. 5A and/or 5B), and FIG. 5D is an example code analysis view related to the code view of FIG. 5C created by the described systems and methods (and which may be overlaid or displayed adjacent to FIGS. 5A, 5B, and/or 5C). As shown in FIG. 5A, display data 500 may represent the first set of candidate code objects as a hierarchical tree comprising a root node and a plurality of child nodes. Each node may be color-and/or pattern-coded to indicate whether the code represented by the node is functional or not fully functional, also referred to as “buggy”. An additional root node may be introduced to allow multiple initial drafts of a code object to be represented within one tree structure. The additional root node may be visualized as a pie chart to indicate the distribution of functional and buggy nodes within the tree.

Due to the introduction of the additional root node, nodes representing an initial draft of a code object may be second-level nodes. The second-level nodes may be connected to the root node using dashed lines to indicate the root node is not a common ancestor. The lines between each child node and their respective parent node may have varying thicknesses to indicate the extent the code corresponding with the parent node has been altered. The child node of a parent node that is functional may alter the code as part of an improvement function. The child node of a parent node that is not functional may alter the code as part of a debug function.

Interacting with each node in a first manner may cause display data 500 to show the corresponding code, such as shown in FIG. 5C. The depiction of the code may also include indicators of differences between the selected node's code and a root node's code. An indicator of a difference may include depicting deletions in a first color and depicting insertions in a second color. The depiction of the code may also depict an analysis report, such as shown in FIG. 5D. The analysis report may evaluate and summarize the behavior of the LLM in the selected node. More details regarding the analysis report can be found in the below discussion of FIG. 10.

Interacting with a node in a second manner may cause display data 500 to show a corresponding agent plan, such as shown in FIG. 5B. For example, an agent plan may indicate bugs (e.g., areas of a code that may cause the code object to not function or terminate correctly) associated with a parent node and changes in the code corresponding to the selected node to address the bugs.

In some non-limiting embodiments or aspects, a node may contain a step identifier (ID). A step ID may indicate the node's order in the system's solution-seeking process. A step ID may be underlined if the corresponding node is an internal node. Interacting with an internal node in a third manner may result in collapsing a branch of the tree structure starting from that node.

A functioning node may also display a performance parameter, such as an evaluation metric value. The evaluation metric value may be calculated using the root mean squared error (RMSE). The best-performing node in a tree may have its metric value underlined. A node may also have an arc (e.g., a blue arc) surrounding the node to indicate the execution time of the corresponding code.

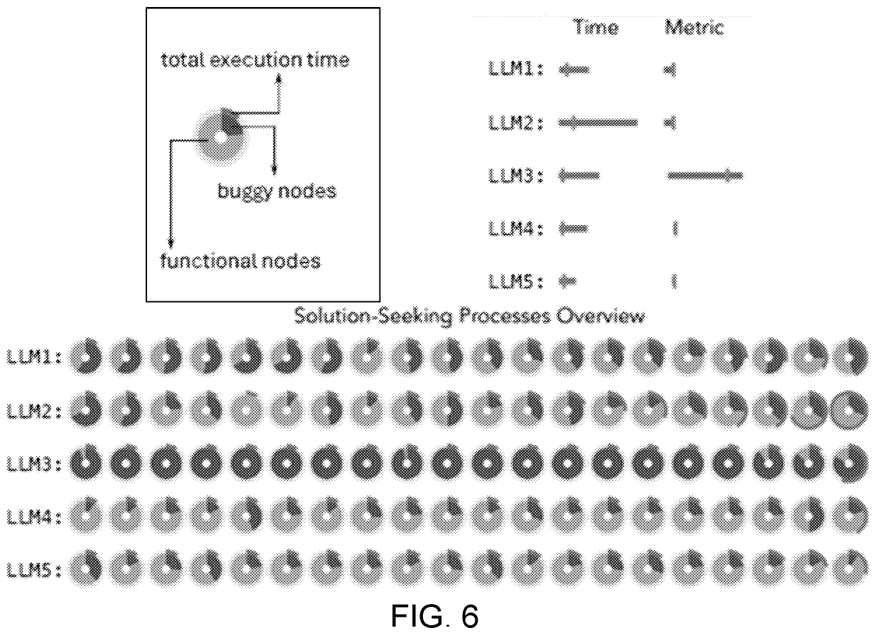

Referring now to FIG. 6, shown is an exemplary diagram and tables comparing multiple coding models, according to some non-limiting embodiments or aspects. FIG. 6 may be used to represent separate steps of tree structure generation, as described in relation to FIGS. 5A-5D, in the solution-seeking process. The pie chart corresponding to the additional root node of a first tree structure may be compared to at least one additional pie chart corresponding to the additional root node of an additional tree structure. For example, as depicted in FIG. 6, five rows and twenty columns of additional root nodes are shown in one table. Each row may correspond to a different coding LLM. The table may also include two additional columns depicting aggregated statistics corresponding to each LLM, such as execution time and the evaluation metric. The aggregated statistics may be depicted with bars indicating the minimum and maximum values and a tick mark indicating the average value, for the given model. The aggregated statistics and pie charts in FIG. 6 may create a visualized comparison allowing a reviewer to determine which LLM produces the best-performing codes and/or the most efficient codes.

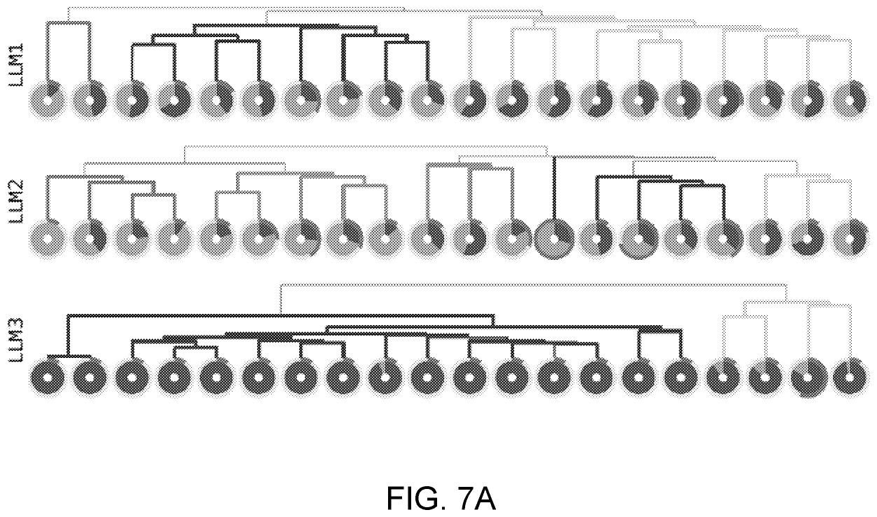

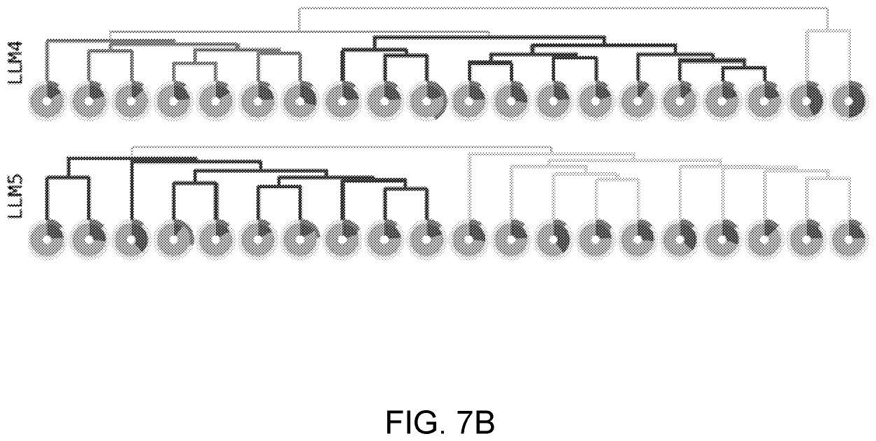

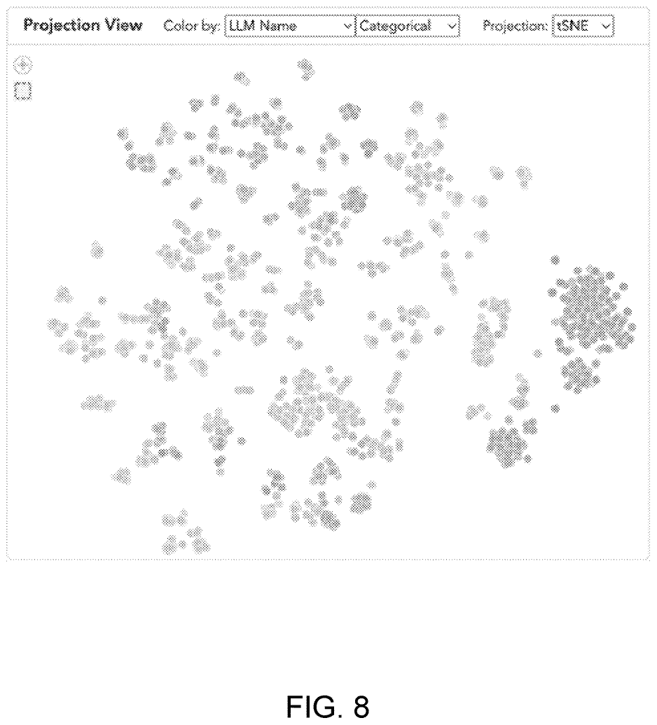

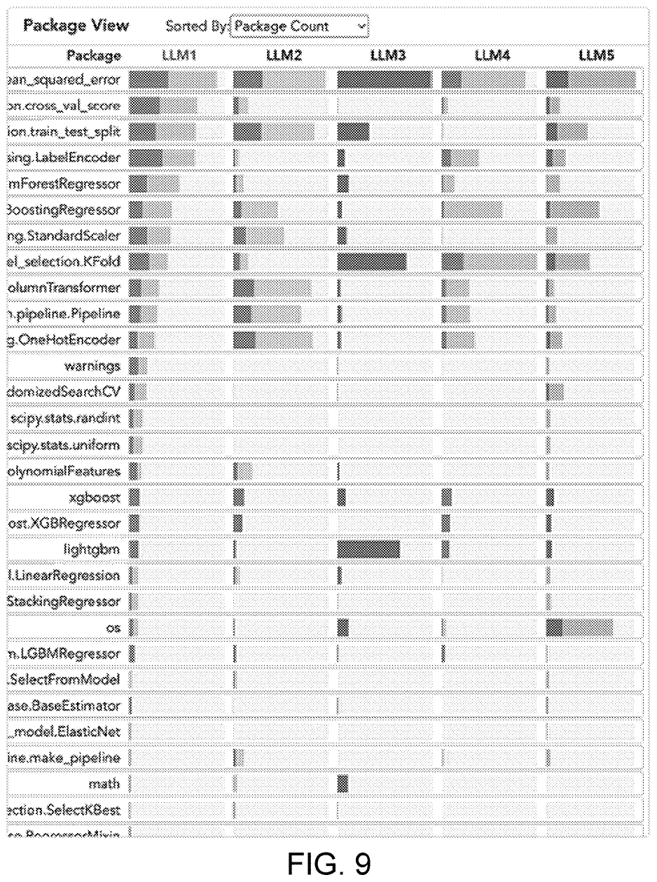

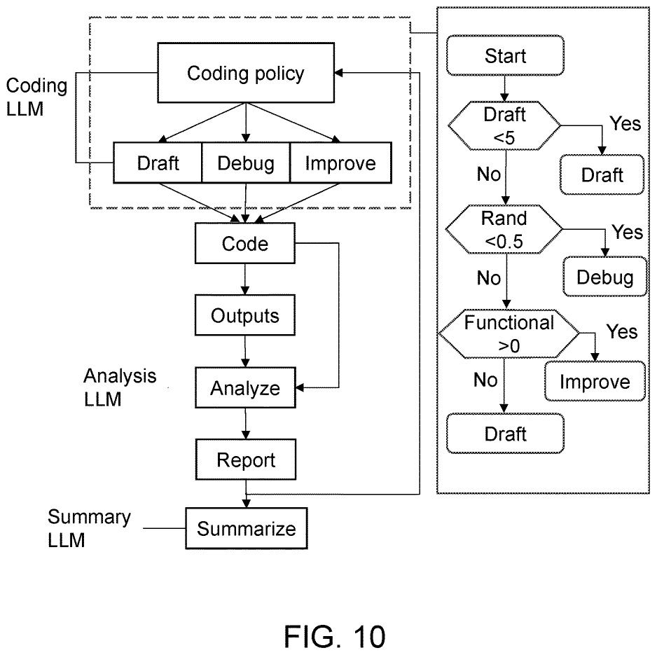

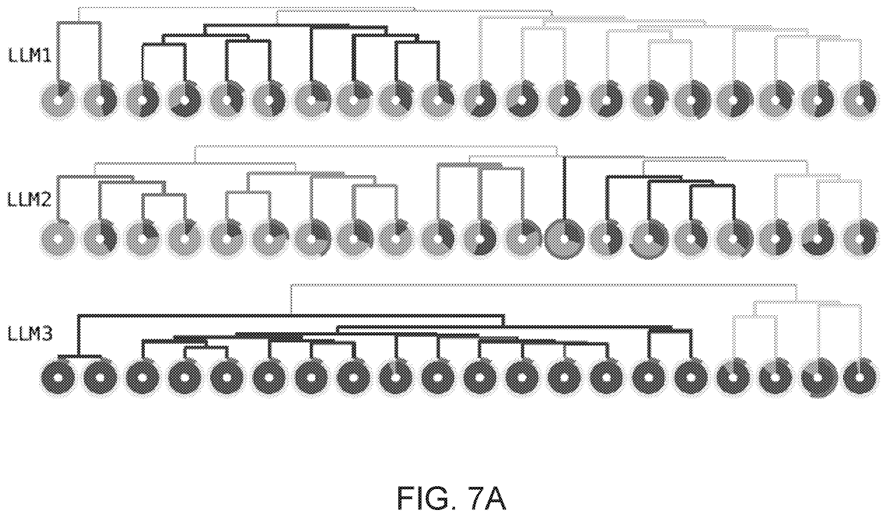

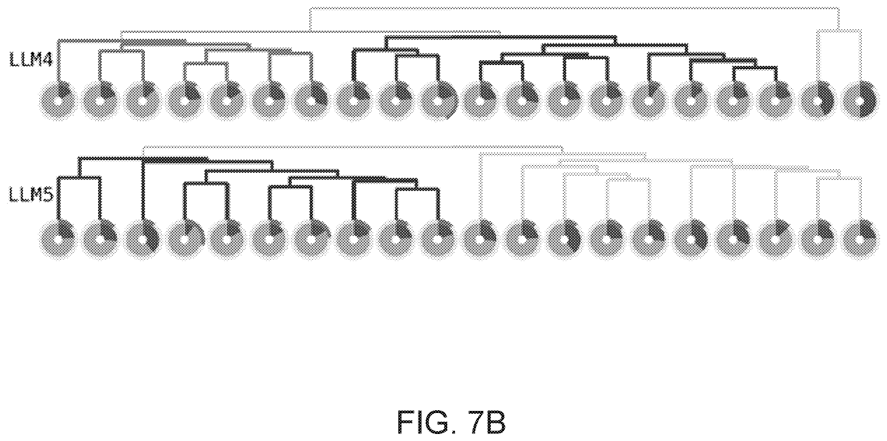

The nodes in each row may be ordered according to at least one of the following metrics: total time used to generate each tree; best evaluation metric value in each tree; number of buggy nodes in each tree; and tree structure similarity. Tree structure similarity may be determined based on the number of edits required to transform one tree into another. Based on the comparison between the pairs of trees, a similarity matrix may be generated. Hierarchical clustering may then be applied to the similarity matrix to group similar trees. The results may be displayed in a dendrogram with a leaf order corresponding to the order of the root nodes. Example dendrograms for the models of the table of FIG. 6 are shown in FIGS. 7A and 7B. Clustering may allow reviewers to choose one representative tree per cluster to review.

Referring now to FIG. 8, shown is an exemplary scatterplot of the code reflected in the tables of FIG. 6, according to some non-limiting embodiments or aspects. The different coding LLMs represented by each row of the table may also be represented in a projection view. Each piece of code may be encoded into an embedding space. In some non-limiting embodiments or aspects, the text of each code may be fed into a separate LLM to generate a high-dimensional (e.g., 300+ dimensional) embedding vector. A matrix may be created with a size equal to the number of pieces of codes (e.g., 300). Dimensionality reduction techniques may then be used to reduce the matrix size to become 2-dimensional, such that the matrix becomes graphable as a scatterplot with points corresponding to each piece of code. The dimensionality reduction techniques may include, but are not limited to: Principal Component Analysis (PCA); t-Distributed Stochastic Neighbor Embedding (t-SNE); Uniform Manifold Approximation and Projection (UMAP); and/or the like. In some non-limiting embodiments or aspects, users may switch between dimensionality reduction techniques and generate a scatterplot based on each technique.

Each point may be color-and/or pattern-coded to indicate at least one of the following: the coding LLM used; the functionality of the code; the execution time; and other variables. The points in FIG. 8 may be color-and/or pattern-coded to indicate the coding LLM used. Color-and/or pattern-coding to indicate the coding LLM used may allow a reviewer to visualize that the plotted coding LLMs utilize dissimilar coding behaviors.

The scatterplot may also include zooming and selection capabilities to allow users to focus on desired areas. When a user selects two points in the scatterplot, a summary of the differences between the codes may be produced under the scatterplot. The summary may be an output of an LLM. The LLM may have been fed the following prompt or a similar one: “You are given two collections of codes. Summarize the difference between them. The first collection is {code 1}, the second collection is {code 2}. Please be concise in your response and use bullet points.” In response, an LLM may output an analysis of the differences in the code collections. For example, based on the exemplary scatterplot of FIG. 8, and given the input of a first collection from LLM₄ as {code 1} and given the input of a second collection from LLM₁, LLM₂, LLM₃, and LLM₅ as {code 2}, the LLM may output: “Difference between the two collections of code: the two collections of code focus on different machine learning techniques and operations for house price prediction using structured data. Here are the summarized differences: First Collection. Techniques and Models: Uses various machine learning models, including Light Gradient-Boosting Machine (LightGBM), Extreme Gradient Boosting (XGBoost), and Gradient Boosting Regressor. Different configurations involve changes in estimators and learning rates. Data Preparation: Data splitting involves more granularity with several files using train-test splits and cross-validation directly performed in the code. Feature Engineering: Includes detailed manipulation, removal of specific columns, and log . . . ”, for exemplary purposes only. Such an interpretation of differences in the output may be shown in a view adjacent and/or overlapping the scatterplot.

Referring now to FIG. 9, provided is an exemplary bar matrix of various packages used in the exemplary codes reflected in the tables of FIG. 6. In some non-limiting embodiments or aspects, the frequency that a package is imported into a code may be depicted in a matrix of bar charts. Abstract syntax tree (AST) analysis may be performed on each piece of code to extract the packages used. The resulting package frequencies may be visualized in the matrix of bar charts shown in FIG. 9. Each row may represent a specified package, and each column may represent a coding LLM. The length of the bar may indicate the number of times that the corresponding package is used in the corresponding coding LLM. The bar may be color-and/or pattern-coded to indicate the coding LLM used. The color coding of the bar may match the color coding of the scatterplot. The bar may be further color-and/or pattern-coded to include both a light shade and a dark shade. The dark shade may indicate the count of buggy code using that package.

Interacting with the name of each coding LLM may sort the columns so that the rows are sorted based on the package frequency in descending order. The bars may also be sorted by the ratio of buggy nodes. This sorting mechanism may help identify potentially problematic packages. By providing the user with the depiction of packages used and proportion of functional code implementations, the user may readily identify the most important packages for code deployment and which packages may be contributing to buggy deployment.

Referring now to FIG. 10, provided is a schematic diagram of a system for machine learning model visualization and optimized deployment, according to some non-limiting embodiments or aspects. As shown, the system may include at least two different LLMs. The at least two different LLMs may have three primary functions. The first primary function may be coding. For example, a coding-LLM may take a problem description, data description, and evaluation metric as input. The coding LLM may use the input to generate a paragraph outlining a plan to solve the problem and a piece of code based on the plan. The code may be written in Python. The coding LLM may execute the code and save the outputs, which may include error logs for buggy code or an evaluation metric value for functional code.

The coding LLM may determine whether to start a code from scratch, fix a bug from an earlier iteration, or improve a previously functional code based on a coding policy. The coding policy may check the number of nodes currently generated at the start of an iteration and halt the process if a specified number of total nodes have already been generated. If not, the coding policy may determine whether a new initial node should be drafted or if a current node should be debugged or improved. If the number of initial nodes is less than a specified number of initial nodes, the coding policy may instruct the coding LLM to start a code from scratch. If the number of initial nodes is equal to or greater than a specified number of initial nodes, the coding policy will randomly determine whether to debug or improve a code. If the coding policy chooses to improve a node but all current codes are buggy, the coding policy may instruct the coding LLM to start a code from scratch. If the coding policy chooses to improve a node and there are multiple functional nodes, the coding policy will instruct the coding LLM to improve the functional node with the highest evaluation metric value.

The second primary function may be analysis. For example, an analysis LLM may take the generated plan, the code, and the execution output as input. The analysis LLM may use the input to evaluate the results and generate a paragraph of text outlining the analysis. The analysis LLM may be repeatedly called to generate a solution for every node in a tree.

The third primary function may be summarizing. For example, a summary LLM may take all the plans, codes, and analysis reports as input. The summary LLM may use the input to generate a summary of the entire process. The summary LLM may not be called until the coding LLM and the analysis LLM have finished running iterations.

The coding function may be performed by multiple different coding LLMs so that each coding LLM's behavior may be compared. Based on the comparison, an optimal LLM may be chosen for each task moving forward. The analysis function may be consistently performed by the same analysis LLM. The summary function may be consistently performed by the same summary LLM. The coding LLM, analysis LLM, and/or summary LLM may be the same LLM.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system, comprising:
at least one processor configured to:
generate a first set of candidate code objects using a first machine learning model, wherein, when generating the first set of candidate code objects, the at least one processor is configured to:
generate at least one first candidate code object of the first set of candidate code objects without referencing an earlier-generated candidate code object of the first set of candidate code objects;
generate at least one second candidate code object of the first set of candidate code objects by debugging an earlier-generated candidate code object of the first set of candidate code objects that is non-functional; and
generate at least one third candidate code object of the first set of candidate code objects by improving an earlier-generated candidate code object of the first set of candidate code objects that is functional;
determine, for each candidate code object of the first set of candidate code objects, at least one value of at least one performance parameter; and
deploy a selected code object of the first set of candidate code objects in a production environment based at least partly on the selected code object having an optimized value of the at least one performance parameter.

2. The system of claim 1, wherein the at least one processor is configured to generate each candidate code object of the first set of candidate code objects in series.

3. The system of claim 2, wherein the first set of candidate code objects comprises at least thirty candidate code objects, and wherein, when generating the first set of candidate code objects, the at least one processor is configured to generate at least a first five generated candidate code objects of the first set of candidate code objects without referencing an earlier-generated candidate code object of the first set of candidate code objects.

4. The system of claim 3, wherein, when generating the first set of candidate code objects, the at least one processor is configured to, after at least the first five generated candidate code objects are generated, generate a remainder of the first set of candidate code objects by debugging an earlier-generated candidate code object of the first set of candidate code objects that is non-functional, or improving an earlier-generated candidate code object of the first set of candidate code objects that is functional.

5. The system of claim 1, wherein the at least one processor is further configured to:
generate display data configured to represent the first set of candidate code objects as a hierarchical tree comprising a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node; and
cause the hierarchical tree to be displayed in a user interface based on the display data.

6. The system of claim 5, wherein the at least one processor is further configured to:
receive, via the user interface, a selection of the child node of the plurality of child nodes;
generate, using a second machine learning model, a description based on how a candidate code object associated with the child node was generated using the first machine learning model; and
provide the description via the user interface.

7. The system of claim 1, wherein the at least one performance parameter comprises at least one of: a functional status of an executed code object; a runtime of an executed code object; a similarity of an executed code object to another code object; an error metric associated with a predictive performance of an executed code object; or any combination thereof.

8. The system of claim 1, wherein the at least one processor is further configured to generate a plurality of sets of candidate code objects using a plurality of machine learning models, wherein each set of the plurality of sets of candidate code objects is associated with a machine learning model of the plurality of machine learning models, and wherein, when generating each set of candidate code objects, the at least one processor is configured to:
generate at least one first candidate code object of the set of candidate code objects without referencing an earlier-generated candidate code object of the set of candidate code objects;
generate at least one second candidate code object of the set of candidate code objects by debugging an earlier-generated candidate code object of the set of candidate code objects that is non-functional; and
generate at least one third candidate code object of the set of candidate code objects by improving an earlier-generated candidate code object of the set of candidate code objects that is functional.

9. The system of claim 8, wherein the at least one processor is further configured to generate display data configured to represent each set of the plurality of sets of candidate code objects as at least a respective root node of a plurality of root nodes, and wherein each root node of the plurality of root nodes is configured to be rendered visually based at least partly on a proportion of candidate code objects that are functional in a set of candidate code objects associated with the root node.

10. The system of claim 8, wherein the at least one processor is further configured to:
generate a multi-dimensional embedding associated with each candidate code object of each set of candidate code objects of the plurality of sets of candidate code objects, to produce a plurality of multi-dimensional embeddings, each dimension of the multi-dimensional embedding based on content of the candidate code object or associated with a performance parameter of the candidate code object; and
display a visual representation of the plurality of multi-dimensional embeddings in a two-dimensional graph using a two-dimensional projection of the plurality of multi-dimensional embeddings,
wherein embeddings of the plurality of multi-dimensional embeddings associated with candidate code objects generated by a same machine learning model are rendered using at least one common visual parameter.

11. A computer-implemented method, comprising:
generating, with at least one processor, a first set of candidate code objects using a first machine learning model, wherein generating the first set of candidate code objects comprises:
generating at least one first candidate code object of the first set of candidate code objects without referencing an earlier-generated candidate code object of the first set of candidate code objects;
generating at least one second candidate code object of the first set of candidate code objects by debugging an earlier-generated candidate code object of the first set of candidate code objects that is non-functional; and
generating at least one third candidate code object of the first set of candidate code objects by improving an earlier-generated candidate code object of the first set of candidate code objects that is functional;
determining, with at least one processor, for each candidate code object of the first set of candidate code objects, at least one value of at least one performance parameter; and
deploying, with at least one processor, a selected code object of the first set of candidate code objects in a production environment based at least partly on the selected code object having an optimized value of the at least one performance parameter.

12. The computer-implemented method of claim 11, further comprising:
generating, with at least one processor, display data configured to represent the first set of candidate code objects as a hierarchical tree comprising a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node; and
causing, with at least one processor, the hierarchical tree to be displayed in a user interface based on the display data.

13. The computer-implemented method of claim 11, further comprising generating, with at least one processor, a plurality of sets of candidate code objects using a plurality of machine learning models, wherein each set of the plurality of sets of candidate code objects is associated with a machine learning model of the plurality of machine learning models, and wherein generating each set of candidate code objects comprises:
generating at least one first candidate code object of the set of candidate code objects without referencing an earlier-generated candidate code object of the set of candidate code objects;
generating at least one second candidate code object of the set of candidate code objects by debugging an earlier-generated candidate code object of the set of candidate code objects that is non-functional; and
generating at least one third candidate code object of the set of candidate code objects by improving an earlier-generated candidate code object of the set of candidate code objects that is functional.

14. The computer-implemented method of claim 13, further comprising generating, with at least one processor, display data configured to represent each set of the plurality of sets of candidate code objects as at least a respective root node of a plurality of root nodes, wherein each root node of the plurality of root nodes is configured to be rendered visually based at least partly on a proportion of candidate code objects that are functional in a set of candidate code objects associated with the root node.

15. The computer-implemented method of claim 13, further comprising:
generating, with at least one processor, a multi-dimensional embedding associated with each candidate code object of each set of candidate code objects of the plurality of sets of candidate code objects, to produce a plurality of multi-dimensional embeddings, each dimension of the multi-dimensional embedding based on content of the candidate code object or associated with a performance parameter of the candidate code object; and
displaying, with at least one processor, a visual representation of the plurality of multi-dimensional embeddings in a two-dimensional graph using a two-dimensional projection of the plurality of multi-dimensional embeddings,
wherein embeddings of the plurality of multi-dimensional embeddings associated with candidate code objects generated by a same machine learning model are rendered using at least one common visual parameter.

16. A computer program product comprising at least one non-transitory computer-readable medium including program instructions that, when executed by at least one processor, cause the at least one processor to:
generate a first set of candidate code objects using a first machine learning model, wherein the program instructions that cause the at least one processor to generate the first set of candidate code objects cause the at least one processor to:
generate at least one first candidate code object of the first set of candidate code objects without referencing an earlier-generated candidate code object of the first set of candidate code objects;
generate at least one second candidate code object of the first set of candidate code objects by debugging an earlier-generated candidate code object of the first set of candidate code objects that is non-functional; and
generate at least one third candidate code object of the first set of candidate code objects by improving an earlier-generated candidate code object of the first set of candidate code objects that is functional;
determine, for each candidate code object of the first set of candidate code objects, at least one value of at least one performance parameter; and
deploy a selected code object of the first set of candidate code objects in a production environment based at least partly on the selected code object having an optimized value of the at least one performance parameter.

17. The computer program product of claim 16, wherein the program instructions further cause the at least one processor to:
generate display data configured to represent the first set of candidate code objects as a hierarchical tree comprising a root node and a plurality of child nodes, wherein the root node is associated with the first machine learning model, each child node of the plurality of child nodes is associated with a candidate code object of the first set of candidate code objects, and each child node of the plurality of child nodes is configured to be rendered visually based on the at least one value of the at least one performance parameter of the candidate code object associated with the child node; and
cause the hierarchical tree to be displayed in a user interface based on the display data.

18. The computer program product of claim 16, wherein the program instructions further cause the at least one processor to generate a plurality of sets of candidate code objects using a plurality of machine learning models, wherein each set of the plurality of sets of candidate code objects is associated with a machine learning model of the plurality of machine learning models, and wherein the program instructions that cause the at least one processor to generate each set of candidate code objects cause the at least one processor to:
generate at least one first candidate code object of the set of candidate code objects without referencing an earlier-generated candidate code object of the set of candidate code objects;
generate at least one second candidate code object of the set of candidate code objects by debugging an earlier-generated candidate code object of the set of candidate code objects that is non-functional; and
generate at least one third candidate code object of the set of candidate code objects by improving an earlier-generated candidate code object of the set of candidate code objects that is functional.

19. The computer program product of claim 18, wherein the program instructions further cause the at least one processor to generate display data configured to represent each set of the plurality of sets of candidate code objects as at least a respective root node of a plurality of root nodes, and wherein each root node of the plurality of root nodes is configured to be rendered visually based at least partly on a proportion of candidate code objects that are functional in a set of candidate code objects associated with the root node.

20. The computer program product of claim 18, wherein the program instructions further cause the at least one processor to:
generate a multi-dimensional embedding associated with each candidate code object of each set of candidate code objects of the plurality of sets of candidate code objects, to produce a plurality of multi-dimensional embeddings, each dimension of the multi-dimensional embedding based on content of the candidate code object or associated with a performance parameter of the candidate code object; and
display a visual representation of the plurality of multi-dimensional embeddings in a two-dimensional graph using a two-dimensional projection of the plurality of multi-dimensional embeddings,
wherein embeddings of the plurality of multi-dimensional embeddings associated with candidate code objects generated by a same machine learning model are rendered using at least one common visual parameter.
